(19) United States
(12) Patent Application Publication
(10) Pub. No.: US 2012/0147491 A1
(43) Pub. Date: Jun. 14, 2012

(54) Reflective Film and Method of Manufacturing the Same

(75) Inventor: Makoto TSUNEKAWA, Ibaraki-shi (JP)

(73) Assignee: NITTO DENKO CORPORATION, Osaka (JP)

(21) Appl. No.: 13/231,281

(22) Filed: Sep. 13, 2011

(30) Foreign Application Priority Data
Dec. 8, 2010 (JP) 2010-273537

(51) Int. Cl. G02B 5/08; B05D 1/36; B05D 5/06; G02B 1/12; C23C 28/00

(52) U.S. Cl. 359/883; 359/838; 205/183; 427/162

(57) ABSTRACT

A substrate includes an insulating layer and a reflective film. The reflective film includes a conductor layer, a barrier layer and a thin silver film in this order. The surface of the conductor layer is subjected to planarization processing to attain not more than 0.35 μm. The surface roughness of the barrier layer is not more than 0.2 μm. The conductor layer is formed on the insulating layer. The thin silver film is formed on the conductor layer with the barrier layer sandwiched therebetween. The thin silver film on the conductor layer has a surface roughness of not more than 0.2 μm, a gloss level of not less than 0.8 and a reflectivity of not less than 90% for light of a wavelength of 460 nm.

### BACKGROUND OF THE INVENTION

1. Field of the Invention

The present invention relates to a reflective film and a method of manufacturing the same.

2. Description of the Background Art

Reflective films are utilized as reflective members for light sources such as light emitting diodes (LEDs) because of their high light reflectivities. The recent development of light sources that emit short wavelength light has led to proposal for thin silver films having high reflectivities for light of short wavelengths (see JP 2005-347375 A and JP 2008-16674 A, for example).

JP 2005-347375 A discloses a stem for light emitting device in which a gloss silver plating layer is formed on the entire surface of a basis material with a gloss nickel plating layer sandwiched therebetween. In this stem for light emitting device, the reflectivity of the gloss silver plating layer for ultraviolet rays near a wavelength of 400 nm is not less than 80%.

JP 2008-16674 A discloses a silver film having a silver plating layer whose crystal particle diameter on its outermost surface is set to not less than 0.5 μm and not more than 30 μm. The reflectivity of the silver film for light in a visible light region is about 90 to 99%.

A reflective member using the gloss silver plating layer disclosed in JP 2005-347375 A or the silver film disclosed in JP 2008-16674 A is provided in an LED, so that light emitted rearward from the LED can be reflected forward with high efficiency. This improves extraction efficiency of light emitted from the LED.

However, it is difficult to sufficiently improve the extraction efficiency of the light emitted from the LED only by improving the reflectivity of the thin silver film. The light reflected by the reflective film includes specular reflected light and diffuse reflected light. A high reflectivity of the reflective film and a large ratio of the specular reflected light included in the reflected light are required for improving the extraction efficiency of the light from the light source provided on the reflective film.

While the reflectivity in a long wavelength region in the visible light region is comparatively easily increased, it is not easy to increase the reflectivity in a short wavelength region.

### BRIEF SUMMARY OF THE INVENTION

An object of the present invention is to provide a reflective film capable of sufficiently improving extraction efficiency of light from a light source, and a method of manufacturing the same.

(1) According to an aspect of the present invention, a reflective film includes a thin silver film having a surface roughness of not more than 0.2 μm, a gloss level of not less than 0.8 and a reflectivity of not less than 90% for light of a wavelength of 460 nm.

The reflective film includes the thin silver film having the surface roughness of not more than 0.2 μm, thus obtaining a high reflectivity. Moreover, the reflective film has the reflectivity of not less than 90% for light of the wavelength of 460 nm, so that a high reflectivity is obtained in a short wavelength region. Furthermore, the reflective film has the gloss level of not less than 0.8, thereby increasing a ratio of specular reflected light included in reflected light. As a result, extraction efficiency of light from a light source can be sufficiently improved when the light source is provided on the reflective film.

(2) An average crystal particle diameter of a surface of the thin silver film may be not more than 0.5 μm. In this case, irregularities on the surface of the thin silver film can be reduced. This improves the reflectivity and gloss level of the thin silver film.

(3) The reflective film may further include a first underlayer having a surface roughness of not more than 0.2 μm, wherein the thin silver film may be formed on the first underlayer. In this case, the surface roughness of the thin silver film can easily be not more than 0.2 μm. This easily improves the reflectivity of the thin silver film.

(4) The first underlayer may contain copper. In this case, the surface roughness of the first underlayer can be easily adjusted to not more than 0.2 μm.

(5) The reflective film may further include a second underlayer formed between the first underlayer and the thin silver film. Thus, the surface roughness of the thin silver film can be not more than 0.2 μm by adjusting the thickness of the second underlayer even when the surface roughness of the first underlayer is larger than 0.2 μm.

(6) The second underlayer may contain nickel. In this case, the second underlayer can be easily formed on the first underlayer.

(7) The thin silver film may be formed by electrolytic plating. In this case, the thin silver film can be easily formed.

(8) The thin silver film may contain a gloss agent. In this case, the gloss level of the thin silver film can easily be not less than 0.8.

(9) According to another aspect of the present invention, a method of manufacturing a reflective film includes the steps of preparing a first underlayer, and forming a thin silver film having a surface roughness of not more than 0.2 μm, a gloss level of not less than 0.8 and a reflectivity of not less than 90% for light of a wavelength of 460 nm on the first underlayer.

In the method of manufacturing the reflective film, the thin silver film having the surface roughness of not more than 0.2 μm is formed on the first underlayer, thereby obtaining a high reflectivity. Moreover, the reflective film has the reflectivity of not less than 90% for light of the wavelength of 460 nm, so that a high reflectivity is obtained in a short wavelength region. Furthermore, the reflective film has the gloss level of not less than 0.8, thereby increasing a ratio of specular reflected light included in reflected light. As a result, extraction efficiency of light from a light source can be sufficiently improved when the light source is provided on the reflective film.

(10) The step of preparing the first underlayer may include the step of preparing the first underlayer having a surface roughness of not more than 0.2 μm.

In this case, the surface roughness of the thin silver film can easily be not more than 0.2 μm. This easily improves the reflectivity of the thin silver film.

(11) The step of forming the thin silver film may include the step of forming the thin silver film on the first underlayer by electrolytic plating using a silver plating solution to which a gloss agent has been added. In this case, the thin silver film having the gloss level of not less than 0.8 can easily be formed.

(12) The method of manufacturing the reflective film may further include the step of forming a second underlayer having a surface roughness of not more than 0.2 μm on the first underlayer, wherein the step of forming the thin silver film may include the step of forming the thin silver film on the first underlayer with the second underlayer sandwiched between the thin silver film and the first underlayer.

Thus, the surface roughness of the thin silver film can be not more than 0.2 μm by adjusting the thickness of the second underlayer even when the surface roughness of the first underlayer is larger than 0.2 μm.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWINGS

FIG. 1 is a sectional view of a substrate including a reflective film according to an embodiment of the present invention;

FIGS. 2 (a) to (e) are sectional views for use in illustrating steps in a method of manufacturing the reflective film; and

FIGS. 3 (a), (b) are examples of an image of an outermost surface of an acquired thin silver film.

### DETAILED DESCRIPTION OF THE INVENTION

Hereinafter, description will be made of a reflective film according to an embodiment of the present invention while referring to the drawings. In the present embodiment, description will be made of a reflective film formed on a substrate on which a light source such as a light emitting diode (LED) is to be mounted.

### (1) Configuration of the Substrate

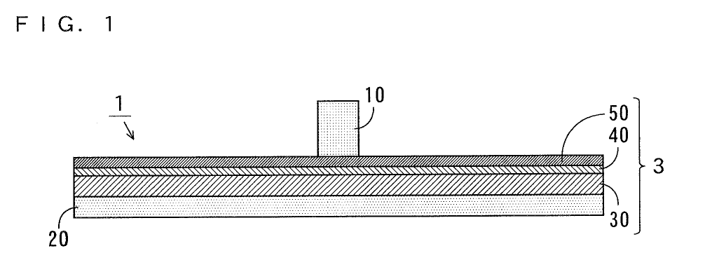

FIG. 1 is a sectional view of the substrate including the reflective film according to the embodiment of the present invention. As shown in FIG. 1, the substrate 1 includes an insulating layer 20 made of polyimide, for example, and a reflective film 3. The reflective film 3 includes a conductor layer 30 made of copper, for example, a barrier layer 40 made of nickel, for example, and a thin silver film 50 in this order. The conductor layer 30 is formed on the insulating layer 20. The thin silver film 50 is formed on the conductor layer 30 with the barrier layer 40 sandwiched therebetween.

The average particle diameter of the surface of the thin silver film 50 is not more than 0.5 μm. The surface roughness Ra of the thin silver film 50 is set to not more than 0.2 μm, as described below.

An LED 10 is mounted on the thin silver film 50. The LED 10 emits light whose center wavelength is 460 nm to all directions. Here, light reflected by the thin silver film 50 at the lower surface of the LED 10 in addition to the light directly emitted from the LED 10 is emitted outward from the LED 10, thereby improving extraction efficiency of light from the LED 10.

### (2) Method of Manufacturing the Reflective Film on the Substrate

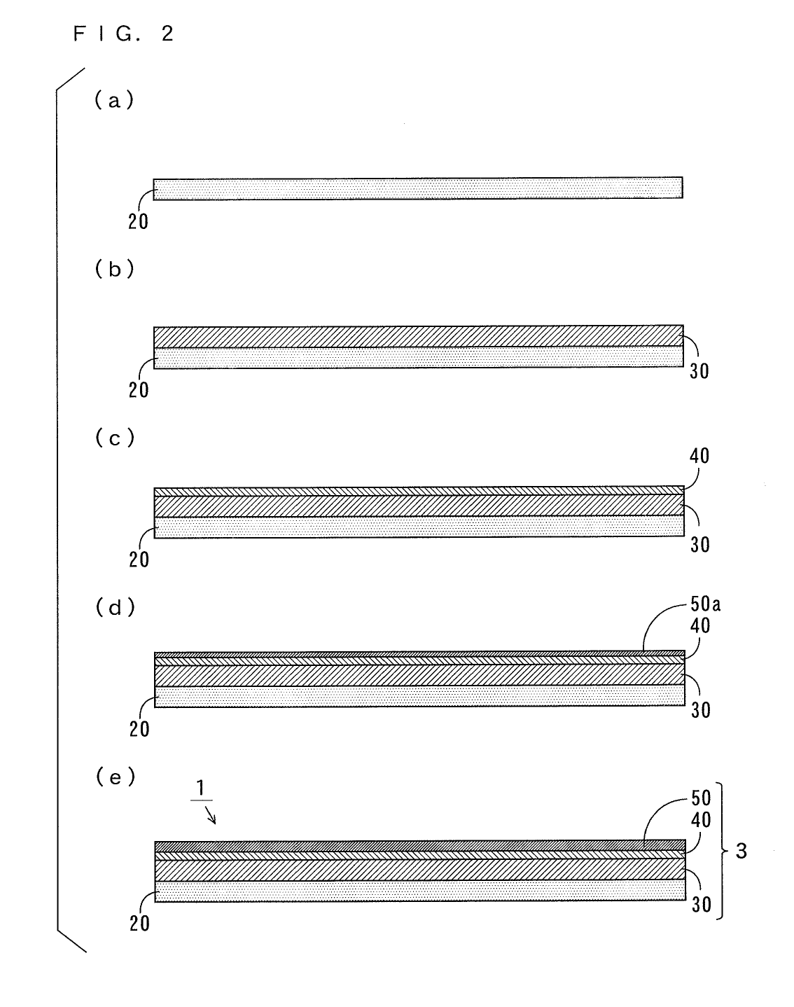

Next, description will be made of a method of manufacturing the reflective film 3 on the substrate 1 shown in FIG. 1. FIG. 2 shows sectional views for use in illustrating steps in the method of manufacturing the reflective film 3.

First, the insulating layer 20 is prepared as shown in FIG. 2 (a). The insulating layer 20 is made of polyimide, for example. Next, the conductor layer 30 is formed on the insulating layer 20, as shown in FIG. 2 (b). The conductor layer 30 is made of copper, for example. Then, the surface of the conductor layer 30 is subjected to planarization processing. The surface roughness Ra of the surface of the conductor layer 30 is not more than 0.35 μm, for example, and preferably not more than 0.2 μm. The planarization processing of the surface of the conductor layer 30 may be performed by etching using a sulfuric acid-hydrogen peroxide etching solution or another method capable of controlling the surface roughness Ra such as grinding. The surface roughness Ra of the conductor layer 30 is adjusted to not more than 0.2 μm, thereby easily setting the surface roughness Ra of the thin silver film 50 to not more than 0.2 μm, as described below.

Next, the barrier layer 40 is formed on the surface of the conductor layer 30 that has been subjected to the planarization processing as show in FIG. 2 (c). The barrier layer 40 is formed by electrolytic gloss nickel plating, for example. In this case, the surface roughness Ra of the surface of the barrier layer 40 is preferably not more than 0.2 μm. A plating underlayer 50a is subsequently formed on the barrier layer 40 as shown in FIG. 2 (d). The plating underlayer 50a is formed by electrolytic silver strike plating, for example.

After that, the thin silver film 50 is formed on the plating underlayer 50a as shown in FIG. 2 (e). The thin silver film 50 is formed by electrolytic plating using a high cyanide bath of silver to which a gloss agent has been added, for example. Here, the plating underlayer 50a is integrated with the thin silver film 50. The average particle diameter of the thin silver film 50 is preferably not more than 0.5 μm. In this case, irregularities of the surface of the thin silver film can be reduced. This improves the reflectivity and gloss level of the thin silver film 50.

The thin silver film 50 formed in this manner on the conductor layer 30 has the surface roughness Ra of not more than 0.2 μm, the gloss level of not less than 0.8 and the reflectivity of not less than 90% for light of a wavelength of 460 nm.

### (3) Effects of the Embodiment

The thin silver film 50 of the reflective film 3 according to the present embodiment has the surface roughness Ra of not more than 0.2 μm, the gloss level of not less than 0.8 and the reflectivity of not less than 90% for light of the wavelength of 460 nm.

The surface roughness Ra of not more than 0.2 μm leads to a high reflectivity. The reflectivity of not less than 90% for light of the wavelength of 460 nm leads to a high reflectivity in the short wavelength region. The gloss level of not less than 0.8 increases the ratio of specular reflected light included in reflected light. As a result, the extraction efficiency of the light from the light source provided on the reflective film 3 can be sufficiently improved.

### (4) Other Embodiments

(4-1) While the barrier layer 40 is provided between the conductor layer 30 and the thin silver film 50 in the above-described embodiment, the present invention is not limited to this. The barrier layer 40 may not be provided between the conductor layer 30 and the thin silver film 50 when the surface roughness Ra of the conductor layer 30 is not more than 0.2 μm.

(4-2) While copper is used as the material for the conductor layer 30 in the above-described embodiment, the present invention is not limited to this. A copper alloy, silver, gold, titanium, platinum or an alloy thereof may be used as the material for the conductor layer 30, for example.

(4-3) While nickel is used as the material for the barrier layer 40 in the above-described embodiment, the present invention is not limited to this. For example, a nickel alloy, palladium, ruthenium, rhodium, platinum, tantalum nitride (TaN) or titanium nitride (TiN) may be used as the material for the barrier layer 40.

(4-4) While the thin silver film 50 is formed by plating in the above-described embodiment, the present invention is not limited to this. For example, the thin silver film 50 may be formed by another method such as sputtering or vapor deposition.

### (5) Correspondences Between Elements in the Claims and Parts in Embodiments

In the following paragraph, non-limiting examples of correspondences between various elements recited in the claims below and those described above with respect to various preferred embodiments of the present invention are explained.

In the above-described embodiment, the thin silver film 50 is an example of a thin silver film, the reflective film 3 is an example of a reflective film, the conductor layer 30 is an example of a first underlayer, and the barrier layer 40 is an example of a second underlayer.

As each of various elements recited in the claims, various other elements having configurations or functions described in the claims can be also used.

### (6) Inventive Examples

(6-1) Inventive Examples and Comparative Examples

The substrate 1 was prepared based on the above-described embodiment in each of inventive examples 1 to 8 and comparative examples 1 to 5.

In the inventive example 1, the surface roughness Ra of the surface of the conductor layer 30 made of copper was adjusted to 0.06 μm by buffing in the step shown in FIG. 2 (b). Next, in the step shown in FIG. 2 (c), the electrolytic gloss nickel plating was performed for five minutes in a condition at a temperature of 50° C. and current density of 5 A/dm², so that the barrier layer 40 having the thickness of 5 μm and the surface roughness Ra of 0.051 μm was formed on the surface of the conductor layer 30 that had been subjected to the planarization processing. The electrolytic silver strike plating was subsequently performed for fifteen seconds in a condition at a temperature of 25° C. and current density of 2 A/dm², so that the plating underlayer 50a was formed on the barrier layer 40 in the step shown in FIG. 2 (d).

After that, the electrolytic plating using the high cyanide bath of silver to which a gloss agent (SILVER GLO 3K by Rohm and Haas Japan K.K.) had been added was performed for 2.5 minutes in a condition at a temperature of 25° C. and current density of 2 A/dm², so that the thin silver film 50 having the thickness of 3 μm was formed in the step shown in FIG. 2 (e). The amount of the gloss agent added to the high cyanide bath was 100 ml/L.

In the inventive example 2, the electrolytic gloss nickel plating was performed for three minutes in the condition at the temperature of 50° C. and current density of 5 A/dm² in the step shown in FIG. 2 (c). In addition, the electrolytic plating using the high cyanide bath of silver to which the gloss agent had been added was performed for 1.5 minutes in the condition at the temperature of 25° C. and current density of 2 A/dm² in the step shown in FIG. 2 (e). Excluding the foregoing points, a thin silver film 50 was formed in the same manner as in the inventive example 1. The thickness of the barrier layer 40 was 3 μm, and the surface roughness Ra was 0.053 μm. The thickness of the thin silver film 50 was 1.5 μm.

In the inventive example 3, the surface roughness Ra of the surface of the conductor layer 30 was adjusted to 0.33 μm in the step shown in FIG. 2 (b). In addition, the electrolytic gloss nickel plating was performed for fifteen minutes in the condition at the temperature of 50° C. and current density of 5 A/dm² in the step shown in FIG. 2 (c). Excluding the foregoing points, a thin silver film 50 was formed in the same manner as in the inventive example 1. The thickness of the barrier layer 40 was 15 μm, and the surface roughness Ra was 0.192 μm. The thickness of the thin silver film 50 was 3 μm.

In the inventive example 4, a thin silver film 50 was formed in the same manner as in the inventive example 1 excluding that electrolytic dull nickel plating was performed instead of the electrolytic gloss nickel plating in the step shown in FIG. 2 (c). The thickness of the barrier layer 40 was 3 μm, and the surface roughness Ra was 0.152 μm. The thickness of the thin silver film 50 was 1.5 μm.

In the inventive example 5, a thin silver film 50 was formed in the same manner as in the inventive example 1 excluding that the electrolytic silver strike plating was performed for ten seconds in a condition at a temperature of 25° C. and current density of 4 A/dm² in the step shown in FIG. 2 (d). The thickness of the thin silver film 50 was 3 μm.

In the inventive example 6, a thin silver film 50 was formed in the same manner as in the inventive example 5 excluding that the electrolytic silver strike plating was performed for fifteen seconds in a condition at a temperature of 25° C. and current density of 2 A/dm² in the step shown in FIG. 2 (d). The thickness of the thin silver film 50 was 1 μm.

In the inventive example 7, a thin silver film 50 was formed in the same manner as in the inventive example 5 excluding that the amount of the gloss agent added to the high cyanide bath was 30 ml/L in the step shown in FIG. 2 (e). The thickness of the thin silver film 50 was 3 μm.

In the inventive example 8, a thin silver film 50 was formed in the same manner as in the inventive example 5 excluding that the surface roughness Ra of the surface of the conductor layer 30 was adjusted to 0.179 μm in the step shown in FIG. 2 (b). The thickness of the thin silver film 50 was 3 μm.

In the comparative example 1, a thin silver film 50 was formed in the same manner as in the inventive example 1 excluding that the surface roughness Ra of the surface of the conductor layer 30 was adjusted to 0.33 μm in the step shown in FIG. 2 (b). The thickness of the barrier layer 40 was 5 μm, and the surface roughness Ra thereof was 0.284 μm. The thickness of the thin silver film 50 was 3 μm.

In the comparative example 2, the surface roughness Ra of the surface of the conductor layer 30 was adjusted to 0.33 μm in the step shown in FIG. 2 (b). In the step shown in FIG. 2 (e), the electrolytic plating using the high cyanide bath of silver to which the gloss agent had not been added was performed instead of the electrolytic plating using the high cyanide bath of silver to which the gloss agent had been added. Excluding the foregoing points, a thin silver film 50 was formed in the same manner as in the inventive example 1. The thickness of the barrier layer 40 was 5 μm, and the surface roughness Ra thereof was 0.284 μm. The thickness of the thin silver film 50 was 3 μm.

In the comparative example 3, a thin silver film 50 was formed in the same manner as in the inventive example 5 excluding that the surface roughness Ra of the surface of the conductor layer 30 was adjusted to 0.33 μm in the step shown in FIG. 2 (b). The thickness of the thin silver film 50 was 3 μm.

In the comparative example 4, a thin silver film 50 that was the same as the thin silver film 50 of the inventive example 5 excluding that the surface roughness Ra of the surface of the conductor layer 30 was adjusted to 0.283 μm was formed in the step shown in FIG. 2 (b). The thickness of the thin silver film 50 was 3 μm.

In the comparative example 5, the electrolytic silver strike plating was performed for fifteen seconds in the condition at the temperature of 25° C. and current density of 2 A/dm² in the step shown in FIG. 2 (d). In the step shown in FIG. 2 (e), the electrolytic plating using the high cyanide bath of silver to which the gloss agent had not been added was performed instead of the electrolytic plating using the high cyanide bath of silver to which the gloss agent had been added. Excluding the foregoing points, a thin silver film 50 was formed in the same manner as in the inventive example 5. The thickness of the thin silver film 50 was 3 μm.

(6-2) Characteristics of the Thin Silver Film

The surface roughness Ra, the average particle diameter, the reflectivity for light of the wavelength of 460 nm and the gloss level of each of the thin silver films 50 of the inventive examples 1 to 8 and the comparative examples 1 to 5 were measured. The surface roughness Ra was measured using a non-contact light interference surface roughness meter (Wyko NT3300, 50×0.5× by Nihon Veeco K. K.).

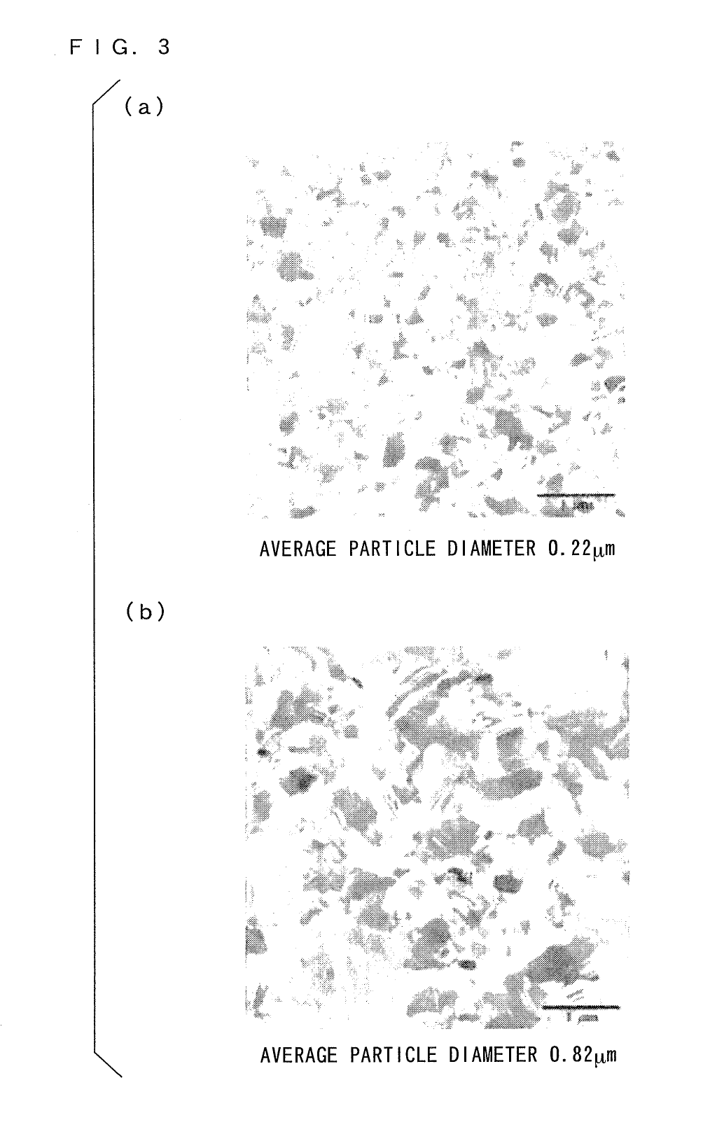

An image magnified by 27000 times of the outermost surface of the thin silver film 50 was acquired using a focused ion beam system (SMI-9200 by SII NanoTechnology Inc.) for measuring the average particle diameter. FIG. 3 shows examples of the image of the outermost surface of the acquired thin silver film 50. FIG. 3 (a) shows the outermost surface of the thin silver film 50 of the inventive example 5, and FIG. 3 (b) shows the outermost surface of the thin silver film 50 of the comparative example 1. In the images shown in FIG. 3, boundaries among particles of the thin silver film 50 were specified using image processing software “ImageJ”. Here, with the diameters of the particles in the longitudinal direction thereof used as the particle diameters, an average value of the particle diameters of the particles in the image was calculated as the average particle diameter. Note that the average particle diameter was an estimated value in the inventive examples 1, 8 and the comparative example 3.

The reflectivity was measured using a spectrophotometer (CM-700d by Konica Minolta Holdings, Inc., view angle of 10°, illumination/light receiving optical system d/8, measurement diameter of 3 mm). The gloss level was measured using a densitometer (ND-11 by Nippon Denshoku Industries Co., Ltd., the measurement diameter of 3 mm).

Table 1 shows evaluation results of the surface roughness Ra, the average particle diameter, the reflectivity for light of the wavelength of 460 nm and the gloss level for each of the thin silver films 50 of the inventive examples 1 to 8 and the comparative examples 1 to 5.

Determination results when the reflectivity was not less than 90% and the gloss level was not less than 0.8 are indicated by “◯”, and determination results when the reflectivity was less than 90% or the gloss level was less than 0.8 are indicated by “X”.

TABLE 1

| | COPPER | NICKEL | | SILVER | | | | | |
|---|---|---|---|---|---|---|---|---|---|
| | SURFACE | | SURFACE | | SURFACE | AVERAGE | | | |
| | ROUGH- | THICK- | ROUGH- | THICK- | ROUGH- | PARTICLE | REFLEC- | | |
| | NESS | NESS | NESS | NESS | NESS | DIAMETER | TIVITY | GLOSS | DETERMI- |
| | [μm] | [μm] | [μm] | [μm] | [μm] | [μm] | [%] | LEVEL | NATION |
| INVENTIVE | 0.06 | 5 | 0.051 | 3 | 0.078 | 0.23 | 93.4 | 1.2 | ◯ |
| EXAMPLE 1 | | | | | | | | | |
| INVENTIVE | 0.06 | 3 | 0.053 | 1.5 | 0.082 | — | 92.8 | 1.2 | ◯ |
| EXAMPLE 2 | | | | | | | | | |
| INVENTIVE | 0.33 | 15 | 0.192 | 3 | 0.185 | — | 90.5 | 1.0 | ◯ |
| EXAMPLE 3 | | | | | | | | | |
| INVENTIVE | 0.06 | 3 | 0.152 | 1.5 | 0.155 | — | 91.7 | 1.0 | ◯ |
| EXAMPLE 4 | | | | | | | | | |
| INVENTIVE | 0.06 | | | 3 | 0.082 | 0.22 | 93.6 | 1.2 | ◯ |
| EXAMPLE 5 | | | | | | | | | |
| INVENTIVE | 0.06 | | | 1 | 0.051 | — | 93.4 | 1.2 | ◯ |
| EXAMPLE 6 | | | | | | | | | |
| INVENTIVE | 0.06 | | | 3 | 0.078 | — | 91.7 | 0.8 | ◯ |
| EXAMPLE 7 | | | | | | | | | |
| INVENTIVE | 0.179 | | | 3 | 0.181 | 0.46 | 90.8 | 1.0 | ◯ |
| EXAMPLE 8 | | | | | | | | | |
| COMPARA- | 0.33 | 5 | 0.284 | 3 | 0.264 | 0.82 | 88.5 | 0.9 | X |
| TIVE | | | | | | | | | |
| EXAMPLE 1 | | | | | | | | | |
| COMPARA- | 0.33 | 5 | 0.284 | 3 | 0.298 | — | 93.1 | 0.2 | X |
| TIVE | | | | | | | | | |
| EXAMPLE 2 | | | | | | | | | |
| COMPARA- | 0.33 | | | 3 | 0.292 | 0.65 | 86.8 | 0.9 | X |
| TIVE | | | | | | | | | |
| EXAMPLE 3 | | | | | | | | | |
| COMPARA- | 0.283 | | | 3 | 0.202 | — | 89.2 | 1.0 | X |
| TIVE | | | | | | | | | |
| EXAMPLE 4 | | | | | | | | | |
| COMPARA- | 0.06 | | | 3 | 0.075 | — | 90.5 | 0.3 | X |
| TIVE | | | | | | | | | |
| EXAMPLE 5 | | | | | | | | | |

As shown in Table 1, the surface roughness Ra, the average particle diameter, the reflectivity for light of the wavelength of 460 nm and the gloss level of the thin silver film 50 of the inventive example 1 were 0.078 μm, 0.23 μm (estimated value), 93.4% and 1.2, respectively. As described above, the reflectivity for light of the wavelength of 460 nm was not less than 90%, and the gloss level was not less than 0.8.

The surface roughness Ra, the reflectivity for light of the wavelength of 460 nm and the gloss level of the thin silver film 50 of the inventive example 2 were 0.082 μm, 92.8% and 1.2, respectively. As described above, the reflectivity for light of the wavelength of 460 nm was not less than 90%, and the gloss level was not less than 0.8.

The surface roughness Ra, the reflectivity for light of the wavelength of 460 nm and the gloss level of the thin silver film 50 of the inventive example 3 were 0.185 μm, 90.5% and 1.0, respectively. As described above, the reflectivity for light of the wavelength of 460 nm was not less than 90%, and the gloss level was not less than 0.8.

The surface roughness Ra, the reflectivity for light of the wavelength of 460 nm and the gloss level of the thin silver film 50 of the inventive example 4 were 0.155 μm, 91.7% and 1.0, respectively. As described above, the reflectivity for light of the wavelength of 460 nm was not less than 90%, and the gloss level was not less than 0.8.

The surface roughness Ra, the average particle diameter, the reflectivity for light of the wavelength of 460 nm and the gloss level of the thin silver film 50 of the inventive example 5 were 0.082 μm, 0.22 μm, 93.6% and 1.2, respectively. As described above, the reflectivity for light of the wavelength of 460 nm was not less than 90%, and the gloss level was not less than 0.8.

The surface roughness Ra, the reflectivity for light of the wavelength of 460 nm and the gloss level of the thin silver film 50 of the inventive example 6 were 0.051 μm, 93.4% and 1.2, respectively. As described above, the reflectivity for light of the wavelength of 460 nm was not less than 90%, and the gloss level was not less than 0.8.

The surface roughness Ra, the reflectivity for light of the wavelength of 460 nm and the gloss level of the thin silver film 50 of the inventive example 7 were 0.078 μm, 91.7% and 0.8, respectively. As described above, the reflectivity for light of the wavelength of 460 nm was not less than 90%, and the gloss level was not less than 0.8.

The surface roughness Ra, the average particle diameter, the reflectivity for light of the wavelength of 460 nm and the gloss level of the thin silver film 50 of the inventive example 8 were 0.181 μm, 0.46 μm (estimated value), 90.8% and 1.0, respectively. As described above, the reflectivity for light of the wavelength of 460 nm was not less than 90%, and the gloss level was not less than 0.8.

The surface roughness Ra, the average particle diameter, the reflectivity for light of the wavelength of 460 nm and the gloss level of the thin silver film 50 of the comparative example 1 were 0.264 μm, 0.82 μm, 88.5% and 0.9, respectively. As described above, the gloss level was not less than 0.8, but the reflectivity for light of the wavelength of 460 nm was less than 90%.

The surface roughness Ra, the reflectivity for light of the wavelength of 460 nm and the gloss level of the thin silver film 50 of the comparative example 2 were 0.298 μm, 93.1% and 0.2, respectively. As described above, the reflectivity for light of the wavelength of 460 nm was not less than 90%, but the gloss level was less than 0.8.

The surface roughness Ra, the average particle diameter, the reflectivity for light of the wavelength of 460 nm and the gloss level of the thin silver film 50 of the comparative example 3 were 0.292 μm, 0.65 μm (estimated value), 86.8% and 0.9, respectively. As described above, the gloss level was not less than 0.8, but the reflectivity for light of the wavelength of 460 nm was less than 90%.

The surface roughness Ra, the reflectivity for light of the wavelength of 460 nm and the gloss level of the thin silver film 50 of the comparative example 4 were 0.202 μm, 89.2% and 1.0, respectively. As described above, the gloss level was not less than 0.8, but the reflectivity for light of the wavelength of 460 nm was less than 90%.

The surface roughness Ra, the reflectivity for light of the wavelength of 460 nm and the gloss level of the thin silver film 50 of the comparative example 5 were 0.075 μm, 90.5% and 0.3, respectively. As described above, the reflectivity for light of the wavelength of 460 nm was not less than 90%, but the gloss level was less than 0.8.

The result of comparison between the inventive examples 1 to 4 and the inventive examples 5 to 8 show that when the surface roughness Ra of the conductor layer 30 was not more than 0.2 μm, the thin silver film 50 having the reflectivity of not less than 90% for light of the wavelength of 460 nm and the gloss level of not less than 0.8 can be formed even though the barrier layer 40 was not formed on the conductor layer 30.

The result of comparison between the inventive examples 1 to 3 and the inventive example 4 show that the thin silver film 50 having the reflectivity of not less than 90% for light of the wavelength of 460 nm and the gloss level of not less than 0.8 can be formed even though the barrier layer 40 was formed by the electrolytic dull nickel plating.

The result of comparison between the inventive examples 5 to 8 and the comparative examples 3, 4 show that when the surface roughness Ra of the conductor layer 30 was not more than 0.2 μm, the thin silver film 50 having the surface roughness Ra of not more than 0.2 μm can be formed even though the barrier layer 40 was not formed on the conductor layer 30. Meanwhile, the result of comparison between the inventive example 3 and the comparative example 1 show that the thin silver film 50 having the surface roughness Ra of not more than 0.2 μm can be formed by forming the barrier layer 40 having the larger thickness on the conductor layer 30 even though the surface roughness Ra of the conductor layer 30 exceeds 0.2 μm. It was found in this case that the surface roughness Ra of the barrier layer 40 of not more than 0.2 μm causes the surface roughness Ra of the thin silver film 50 to be not more than 0.2 μm.

The result of comparison between the inventive examples 1 to 4 and the comparative example 2 and the result of comparison between the inventive examples 5 to 8 and the comparative example 5 show that the thin silver film 50 having the gloss level of not less than 0.8 can be formed by adding the gloss agent to silver regardless of the presence/absence of the barrier layer 40.

The result of comparison between the inventive example 5 and the comparative example 1 show that when the average particle diameter of the thin silver film 50 was not more than 0.5 μm, the thin silver film 50 having the surface roughness Ra of not more than 0.2 μm can be formed.

While preferred embodiments of the present invention have been described above, it is to be understood that variations and modifications will be apparent to those skilled in the art without departing the scope and spirit of the present invention. The scope of the present invention, therefore, is to be determined solely by the following claims.

### INDUSTRIAL APPLICABILITY

The present invention can be effectively utilized in various types of reflective films.

I/We claim:

1. A reflective film comprising a thin silver film having a surface roughness of not more than 0.2 μm, a gloss level of not less than 0.8 and a reflectivity of not less than 90% for light of a wavelength of 460 nm.

2. The reflective film according to claim 1, wherein an average crystal particle diameter of a surface of said thin silver film is not more than 0.5 μm.

3. The reflective film according to claim 1, further comprising a first underlayer having a surface roughness of not more than 0.2 μm, wherein
said thin silver film is formed on said first underlayer.

4. The reflective film according to claim 3, wherein said first underlayer contains copper.

5. The reflective film according to claim 3, further comprising a second underlayer formed between said first underlayer and said thin silver film.

6. The reflective film according to claim 5, wherein said second underlayer contains nickel.

7. The reflective film according to claim 1, wherein said thin silver film is formed by electrolytic plating.

8. The reflective film according to claim 1, wherein said thin silver film contains a gloss agent.

9. A method of manufacturing a reflective film, comprising the steps of:
preparing a first underlayer; and
forming a thin silver film having a surface roughness of not more than 0.2 μm, a gloss level of not less than 0.8 and a reflectivity of not less than 90% for light of a wavelength of 460 nm on said first underlayer.

10. The method of manufacturing the reflective film according to claim 9, wherein the step of preparing the first underlayer includes the step of preparing the first underlayer having a surface roughness of not more than 0.2 μm.

11. The method of manufacturing the reflective film according to claim 9, wherein the step of forming said thin silver film includes the step of forming said thin silver film by electrolytic plating on said first underlayer using a silver plating solution to which a gloss agent has been added.

12. The method of manufacturing the reflective film according to claim 9, further comprising the step of forming a second underlayer having a surface roughness of not more than 0.2 μm on said first underlayer, wherein
the step of forming said thin silver film includes the step of forming said thin silver film on said first underlayer with said second underlayer sandwiched between said thin silver film and said first underlayer.
